(19) United States
(12) Patent Application Publication
(10) Pub. No.: US 2025/0389551 A1
(43) Pub. Date: Dec. 25, 2025

(54) ROTATION DEVICE

(71) Applicant: SUMITOMO HEAVY INDUSTRIES, LTD., Tokyo (JP)

(72) Inventors: Sebastian MARKERT, Markt Indersdorf (DE); Max BOCHMANN, Markt Indersdorf (DE)

(21) Appl. No.: 19/311,641

(22) Filed: Aug. 27, 2025

Related U.S. Application Data
(63) Continuation of application No. PCT/JP2024/003126, filed on Jan. 31, 2024.

(30) Foreign Application Priority Data
Mar. 20, 2023 (JP) 2023-044722

(51) Int. Cl. G01D 5/244; F16H 1/10; F16H 1/32; F16H 19/08

(52) U.S. Cl. CPC G01D 5/244; F16H 2001/323; F16H 19/08; F16H 1/10; F16H 1/32

(57) ABSTRACT

A rotating device includes: a rotator; and a rotation detector that detects rotation of the rotator, in which a tooth group including a plurality of tooth portions meshing with a meshing target member is formed in the rotator, and the rotation detector detects the tooth portion to detect the rotation of the rotator.

### CROSS-REFERENCE TO RELATED APPLICATIONS

This is a bypass continuation of International PCT Application No. PCT/JP2024/003126, filed on January 31, 2024, which claims priority to Japanese Patent Application No. 2023-044722, filed on March 20, 2023, which are incorporated by reference herein in their entirety.

### BACKGROUND

### TECHNICAL FIELD

Certain embodiments of the present disclosure relate to a rotating device. Description of Related Art

The related art discloses a rotating device including a rotator and a rotation detector that detects rotation of the rotator.

### SUMMARY

According to an embodiment of the present invention, there is provided a rotating device. The rotating device includes a rotator, and a rotation detector that detects rotation of the rotator. A tooth group including a plurality of tooth portions meshing with a meshing target member is formed in the rotator, and the rotation detector detects the tooth portion to detect the rotation of the rotator.

According to an embodiment of the present invention, there is provided a rotating device including a high-speed rotator and a low-speed rotator, a gear mechanism that converts rotation of one of the high-speed rotator and the low-speed rotator into rotation of the other, and a first rotation detector that detects rotation of a first rotator which is one of the high-speed rotator and the low-speed rotator. A tooth group including a plurality of tooth portions is formed in the first rotator, and the first rotation detector detects the tooth portion in the first rotator to detect the rotation of the first rotator.

### BRIEF DESCRIPTION OF THE DRAWINGS

FIG. 1 is a side view illustrating a partial cross section of a rotating device according to a first embodiment.

FIG. 2 is an enlarged view of FIG. 1.

FIG. 3 is a sectional view taken along line A-A in FIG. 1.

FIG. 4 is a configuration diagram schematically illustrating a rotation detector of the first embodiment together with a peripheral configuration.

FIG. 5 is a waveform diagram illustrating an example of a detection signal and an incremental signal of the first embodiment.

FIG. 6 is a view when a part of a rotating device of a second embodiment is viewed from the same viewpoint as that in FIG. 2.

FIG. 7 is a side sectional view illustrating a rotating device of a third embodiment.

FIG. 8 is an enlarged view of FIG. 7.

FIG. 9 is a configuration diagram schematically illustrating each rotation detector of a third embodiment together with a peripheral configuration.

FIG. 10 is a configuration diagram schematically illustrating a first rotation detector of a fourth embodiment together with a peripheral configuration.

FIG. 11 is a waveform diagram illustrating an example of an incremental signal detected by the first rotation detector of the fourth embodiment.

FIG. 12 is a configuration diagram schematically illustrating a first rotation detector of a fifth embodiment together with a peripheral configuration.

FIG. 13 is a configuration diagram schematically illustrating a first rotation detector of a sixth embodiment together with a peripheral configuration.

### DETAILED DESCRIPTION

The rotation detector in the related art detects the rotation of the rotator by detecting a target member (encoder disk) attached to the rotator as a detection target. The target member such as a magnetic type encoder disk and an optical type encoder disk is usually very expensive in terms of manufacturing costs, thereby causing a cost increase in the rotating device.

Therefore, it is desirable to provide a rotating device which can achieve cost reduction when a rotation detector is used.

Hereinafter, embodiments for implementing a rotating device of the present disclosure will be described. The same reference numerals will be assigned to the same or equivalent elements, and repeated description will be omitted. In each drawing, components are omitted, enlarged, or reduced as appropriate for convenience of description. The drawings should be viewed in accordance with a direction of the reference numerals.

### FIRST EMBODIMENT

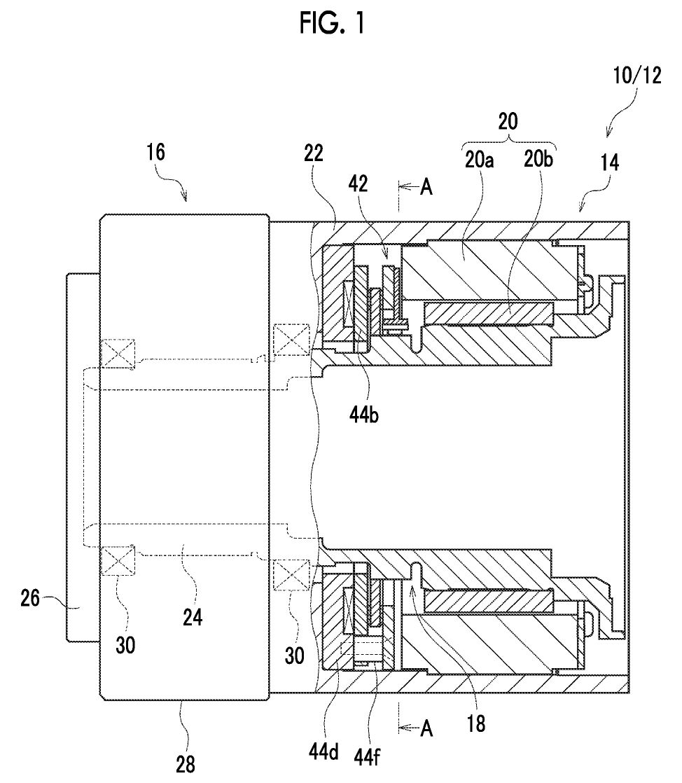

With reference to FIG. 1, a first embodiment will be described. A rotating device 10 of the present embodiment is an actuator 12. The actuator 12 is incorporated in a driven machine as a part of the driven machine, and drives a driven member that is a part of the driven machine. For example, the driven machine includes various machines such as industrial machines (machine tools, construction machines, and the like), robots (industrial robots, service robots, and the like), and transport equipment (conveyors, vehicles, and the like). The actuator 12 includes a motor device 14 and a gear device 16 that decelerates rotation input from the motor device 14 and outputs the rotation to the driven member.

The motor device 14 includes a motor shaft 18, a motor body 20 that rotates the motor shaft 18, and a motor casing 22 (first casing) that accommodates the motor shaft 18 and the motor body 20. The motor body 20 includes a stator 20a fixed to the motor casing 22, and a rotor 20b that rotates integrally with the motor shaft 18. The motor body 20 rotates the motor shaft 18 by means of a rotating magnetic field generated by the stator 20a and the rotor 20b.

The gear device 16 of the present embodiment includes a bending meshing type gear device. The gear device 16 includes an input member 24 to which input rotation is input from the motor shaft 18, a gear mechanism (not illustrated) that decelerates the input rotation of the input member 24, an output member 26 that outputs output rotation decelerated by the gear mechanism to a driven member, and a gear device casing 28 (second casing) that accommodates the input member 24, the gear mechanism, and the like. The motor shaft 18 of the present embodiment is formed integrally with the input member 24, but may be provided as a separate body. The motor shaft 18 and the input member 24 are rotatably supported via a bearing 30 disposed in the motor casing 22 or the like. The gear device casing 28 of the present embodiment is formed integrally with the motor casing 22, but may be provided as a separate body.

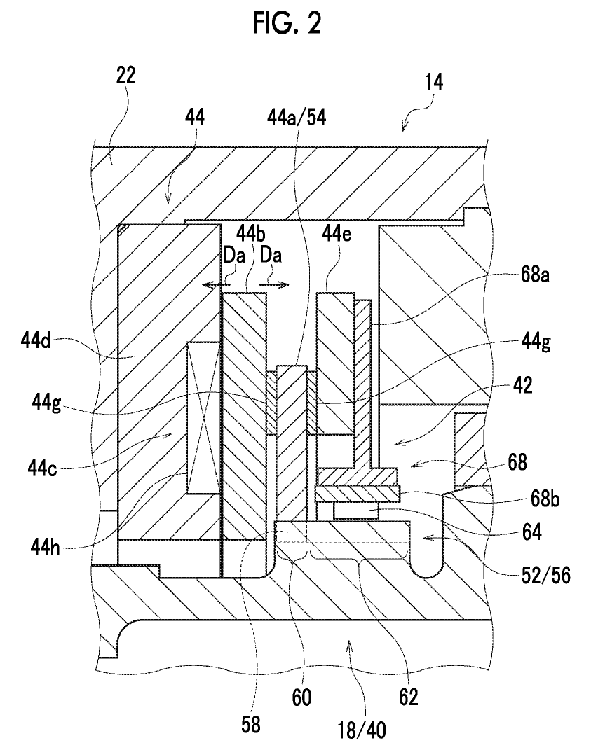

With reference to FIG. 2, the embodiment will be described. The rotating device 10 includes a rotator 40 and a rotation detector 42 that detects rotation of the rotator 40. In addition, the rotating device 10 includes a brake device 44 that brakes the rotation of the rotator 40 as an optional configuration. The rotator 40 of the present embodiment is the motor shaft 18 described above. In the present specification, an axial direction, a radial direction, and a circumferential direction of the rotator 40 may be simply referred to as an axial direction, a radial direction, and a circumferential direction. The rotator 40 and the rotation detector 42 will be described later.

The brake device 44 of the present embodiment is a disc brake. A specific example of the brake device 44 is not particularly limited, and may be a drum brake or the like. The brake device 44 includes a brake rotor 44a integrated with the rotator 40, a movable friction member 44b that brakes the brake rotor 44a, a brake switching mechanism 44c that switches whether or not to perform braking by the movable friction member 44b, and a device body 44d which is fixed to the motor casing 22 and on which the movable friction member 44b or the like is mounted. In addition, as an optional configuration, the brake device 44 includes a fixed friction member 44e disposed on a side opposite to the movable friction member 44b with respect to the brake rotor 44a in the axial direction and supported by the device body 44d.

The movable friction member 44b is supported by a guide member 44f (refer to FIG. 1) to be movable in the axial direction with respect to the device body 44d. The movable friction member 44b is pressed against the brake rotor 44a in a pressing direction Da, and brakes the rotator 40 together with the brake rotor 44a by using friction. In the present embodiment, the brake rotor 44a is pinched between the movable friction member 44b and the fixed friction member 44e, and the brake rotor 44a is braked by the friction between the movable friction member 44b and the fixed friction member 44e. A lining 44g is provided at a contact location among the movable friction member 44b, the fixed friction member 44e, and the brake rotor 44a.

The brake switching mechanism 44c includes a drive unit 44h such as a coil that drives the movable friction member 44b in a drive direction Db by using an electromagnetic force, and a biasing portion (not illustrated) such as a spring that biases the movable friction member 44b to a side opposite to the drive direction in the axial direction (here, the pressing direction Da). The drive unit 44h switches whether or not to perform driving. In this manner, whether or not to press the movable friction member 44b against the brake rotor 44a is switched, and whether or not to perform the braking by the movable friction member 44b is switched.

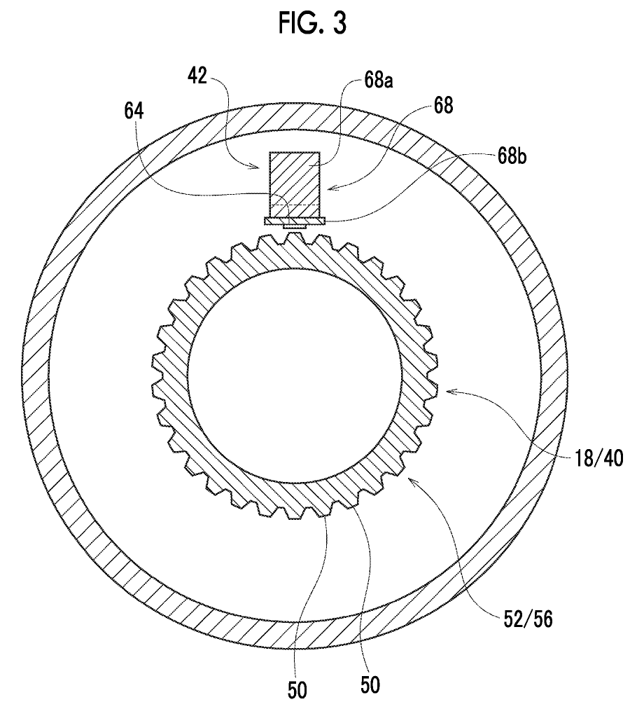

With reference to FIGS. 2, 3, and 4, the embodiment will be described. A tooth group 52 including a plurality of tooth portions 50 is formed in the rotator 40. The plurality of tooth portions 50 are formed at an equal pitch in the circumferential direction on a peripheral surface portion of the rotator 40. The plurality of tooth portions 50 of the present embodiment are formed as external tooth portions on an outer peripheral surface portion of the rotator 40, but may be formed as internal tooth portions on an inner peripheral surface portion of the rotator 40.

A shape of the plurality of tooth portions 50 is not particularly limited. The plurality of tooth portions 50 of the present embodiment form spur teeth in which a tooth root direction is parallel to the axial direction of the rotator 40. In addition, for example, the plurality of tooth portions 50 may form helical teeth in which the tooth root direction is oblique to the axial direction of the rotator 40.

The plurality of tooth portions 50 are formed integrally with a single forming member on a peripheral surface portion of the single forming member forming the rotator 40. The forming member formed integrally with the plurality of tooth portions 50 is continuous over an entire periphery of the rotator 40 at least at a location where the plurality of tooth portions 50 are formed. The number of the forming members forming the rotator 40 is not particularly limited, and either one forming member or a plurality of the forming members may be adopted.

The plurality of tooth portions 50 forming the tooth group 52 mesh with a meshing target member 54. In the present embodiment, the meshing target member 54 is the brake rotor 44a, and the tooth group 52 forms a first spline 56. A second spline 58 that meshes with the tooth group 52 (first spline 56) is formed in the meshing target member 54. The first spline 56 is a male spline, and the second spline 58 is a female spline. However, the first spline 56 may be a female spline, and the second spline 58 may be a male spline. The first spline 56 (tooth group 52) and the second spline 58 mesh with each other such that the rotator 40 and the meshing target member 54 are spline-connected.

Each of the plurality of tooth portions 50 includes a meshing portion 60 that meshes with the meshing target member 54, and an extending portion 62 extending from the meshing portion 60 in the axial direction. The meshing portion 60 is a portion forming the tooth portion 50 in a range in the axial direction in which the meshing portion 60 meshes with the meshing target member 54. The extending portion 62 is a portion forming the tooth portion 50 at a position deviated from the meshing portion 60 in the axial direction, and does not mesh with the meshing target member 54. The meshing portion 60 exists at a position overlapping the meshing target member 54 in the radial direction, and the extending portion 62 does not exist at a position overlapping the meshing target member 54 in the radial direction. In the tooth group 52, the respective numbers of teeth and respective circular pitches are the same in axial cross sections passing through each of the meshing portion 60 and the extending portion 62. The "axial cross section" here refers to a cross section perpendicular to the axial direction. Here, the "circular pitch" refers to an interval between predetermined positions in the adjacent tooth portions 50 of the tooth group 52.

The rotation detector 42 includes a sensor unit 64 that detects the tooth portion 50 (passage of the tooth portion 50), a rotation detection unit 66 that detects the rotation of the rotator 40, based on a detection signal detected by the sensor unit 64, and a detector body portion 68 for mounting the sensor unit 64 and the rotation detection unit 66. The detector body portion 68 is fixed to a forming member different from the rotator 40 of the rotating device 10. In realizing this configuration, the detector body portion 68 includes a fixing member 68a fixed to the forming member and a circuit board 68b fixed to the fixingmember 68a. The forming member to which the detector body portion 68 is fixed is the fixed friction member 44e of the brake device 44 in the present embodiment, but a specific example thereof is not particularly limited.

The sensor unit 64 detects a change in a physical quantity when each of the tooth portions 50 of the tooth group 52 passes through a detection range Ra of the sensor unit 64, thereby detecting the tooth portion 50. The sensor unit 64 is configured to include at least one sensor element (not illustrated) capable of detecting the physical quantity serving as a detection target. For example, the sensor unit 64 is configured to include a sensor chip in which this sensor element is covered with a package. The physical quantity serving as the detection target of the sensor unit of the present embodiment is a magnetic field, and the sensor element is configured to include a Hall IC, a magnetic resistance element, a magnetic impedance element, or the like. In detecting a change in the magnetic field by the sensor unit 64, the rotator 40 formed of a soft magnetic material may be magnetized by a bias magnet or an electromagnet (not illustrated) mounted on the detector body portion 68. In addition, in achieving the same object, the rotator 40 itself may be formed of a magnetized ferromagnetic material. In this manner, when the rotator 40 is rotated, the magnetic field detected by the sensor unit 64 can be periodically changed due to influence of irregularities formed by the respective tooth portions 50, and thus the tooth portion 50 can be detected.

The sensor unit 64 of the present embodiment is disposed to face the tooth group 52 in the radial direction. Specifically, the sensor unit 64 is disposed to face the extending portion 62 of each of the tooth portions 50 in the radial direction in the tooth group 52. In this manner, the sensor unit 64 detects the extending portion 62 of the tooth portion 50. The sensor unit 64 is disposed such that a portion (here, the extending portion 62) serving as the detection target of the tooth portion 50 exists within the detection range Ra of the sensor unit 64. Here, the detection of the tooth portion 50 (passage of the tooth portion 50) is not limited to a configuration in which any portion of the tooth portion 50 is detected. For example, other portions including even a tooth tip or even a tooth bottom may be detected, or even a tooth surface or even a side surface of the tooth portion in the axial direction may be detected.

The rotation detection unit 66 is configured such that hardware elements such as a CPU, a ROM, and a RAM are combined. For example, the rotation detection unit 66 is configured to include a one-chip microcomputer or the like mounted on the detector body portion 68 (circuit board 68b).

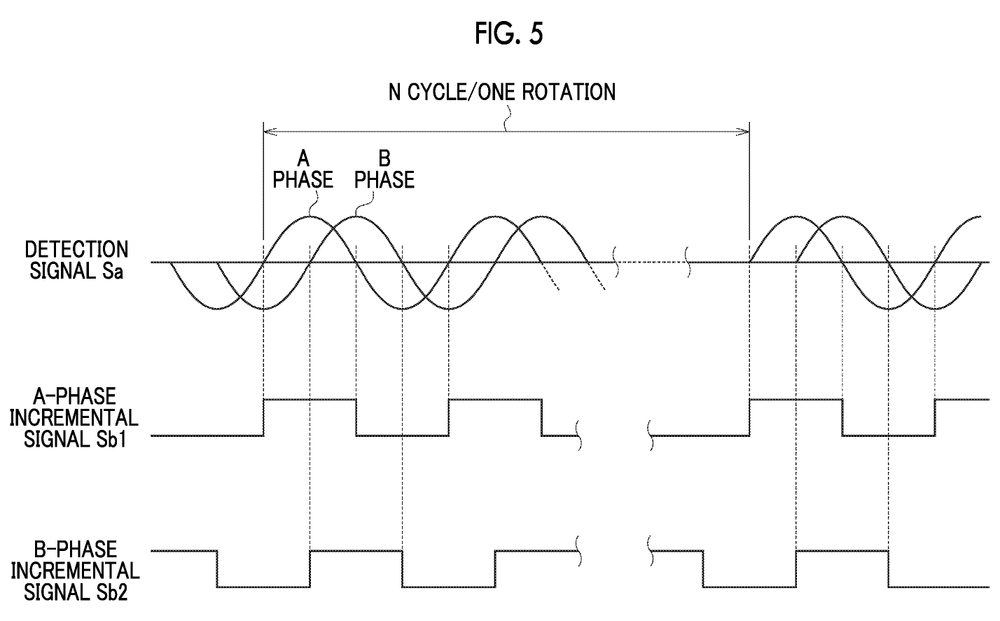

With reference to FIG. 5, description will be continued. A vertical axis and a horizontal axis of a waveform diagram are enlarged or reduced as appropriate for easy understanding. A waveform of the waveform diagram is simplified as appropriate for easy understanding. The sensor unit 64 detects a detection signal Sa indicating the tooth portion 50 detected by the sensor unit 64, and outputs the detection signal Sa to the rotation detection unit 66. The detection signal Sa has a periodic waveform in which the number of cycles N per one rotation of the rotator 40 is the same as the number of teeth of the tooth group 52. For example, the detection signal Sa is detected as detection signals in an A phase and a B phase of a sine wave shape which have a phase difference of 900 from each other. In realizing this configuration, the sensor unit 64 is configured to include at least two sensor elements corresponding to the detection signals in the A phase and the B phase.

In detecting the rotation of the rotator 40, the rotation detection unit 66 of the present embodiment generates incremental signals Sb1 and Sb2, based on the detection signal Sa of the sensor unit 64, and detects a rotation angle of the rotator 40, based on the incremental signals Sb1 and Sb2. In this way, the "detecting the rotation" means that rotation information relating to the rotation of the rotator 40 is detected. Here, an example in which the rotation information is the rotation angle will be described, but the rotation information may be a rotation direction, a rotation speed, an absolute position, or the like of the rotator 40. The sensor unit 64 detects the extending portion 62 of the tooth portion 50. In this manner, the rotation detector 42 detects the rotation of the rotator 40.

In detecting the rotation angle of the rotator 40, the rotation detection unit 66 of the present embodiment generates the incremental signal Sb1 in the A phase and the incremental signal Sb2 in the B phase, which include pulse waveforms, based on the detection signal of the sensor unit 64. The incremental signals Sb1 and Sb2 have a periodic waveform in which the number of pulses per one rotation of the rotator 40 is the same as the number of teeth of the tooth group 52. The incremental signals Sb1 and Sb2 are obtained by performing waveform shaping on the detection signals Sa in the A phase and the B phase. The rotation detection unit 66 counts the number of pulses of the incremental signals Sb1 and Sb2, and detects a count value obtained by counting the number, as the rotation angle of the rotator 40. In counting the number of the incremental signals Sb1 and Sb2, the number of pulses of each of the incremental signals Sb1 and Sb2 may be multiplied (for example, quadrupled) and counted.

The rotation detection unit 66 is electrically connected to a control device (not illustrated). The rotation detection unit 66 outputs rotation information of the rotator 40 which is detected by the rotation detection unit 66 to the control device. The control device controls an operation of the motor device 14 or the like by using the rotation information of the rotator 40 which is output from the rotation detector 42.

Advantageous effects of the above-described rotating device 10 will be described.

A1) When detecting the rotation of the rotator 40, the rotation detector 42 detects the tooth portion 50 by setting the tooth group 52 formed in the rotator 40, as the detection target. Therefore, in detecting the rotation of the rotator 40, a target member serving as the detection target is not attached to the rotator 40. The target member such as a magnetic type encoder disk or an optical type encoder disk is usually very expensive in terms of manufacturing costs. In contrast, the tooth group 52 formed in the rotator 40 can be formed by performing a gear cutting process (skiving process or the like) on a rotator material. Process costs for forming the tooth group 52 by the gear cutting process are usually very inexpensive, compared to the manufacturing costs of the target member. Since this target member requiring high manufacturing costs is omitted and the tooth group 52 requiring low process costs is set as the detection target, it is possible to achieve cost reduction of the rotating device 10.

(A2) In addition, influence of an attachment error caused by attaching the target member to the rotator 40 can be eliminated. Therefore, it is possible to prevent detection accuracy of the rotation detector 42 from being degraded due to the attachment error. In addition, since a fastener such as a screw for attaching the target member to the rotator 40 is not required, it is not necessary to secure a space for the fastener.

(A3) When a plurality of magnetic poles are magnetized in the magnetic type encoder disk, it is known that it is difficult to ensure dimensional accuracy of each magnetic pole. In this regard, when the tooth group 52 is formed in the rotator 40, dimensional accuracy of each tooth portion can be easily ensured by the gear cutting process, compared to when the plurality of magnetic poles are magnetized. Since this tooth group 52 is used to detect the rotation of the rotator 40, it is possible to obtain satisfactory detection accuracy.

A4) The tooth group 52 meshes with the meshing target member 54. Therefore, when the existing rotating device 10 is provided with the tooth group 52 that meshes with the meshing target member 54, the tooth group 52 can be used as the detection target while suppressing a design change in the tooth group 52. For example, when the meshing portion 60 of the tooth portion 50 is detected by the rotation detector 42, the existing meshing portion 60 can be used as it is. Therefore, the design change in the existing tooth group 52 is not required. In addition, when the extending portion 62 of the tooth portion 50 is detected by the rotation detector 42, a design change for newly providing the extending portion 62 may be added in addition to the existing meshing portion 60. Therefore, in incorporating the rotation detector 42 into the existing rotating device 10, it is possible to easily realize the configuration.

Both the meshing portion 60 and the extending portion 62 of the tooth portion 50 can be formed in the rotator 40 by performing the gear cutting process on the rotator material with the same gear cutting tool. Therefore, in order to use the tooth group 52 as a detection target, even when the extending portion 62 is formed in addition to the meshing portion 60 of the tooth portion 50 in the rotator 40, the manufacturing costs are hardly increased. As a result, even in this case, it is possible to achieve an advantageous effect of achieving cost reduction of the rotating device 10 described in (A1). (B) The meshing target member 54 that meshes with the meshing portion 60 exists in the vicinity of the meshing portion 60 of the tooth portion 50. Therefore, when the meshing portion 60 of the tooth portion 50 is detected by the rotation detector 42, and when the rotation detector 42 (sensor unit 64) is disposed in the vicinity of the meshing portion 60, the rotation detector 42 and the meshing target member 54 are likely to interfere with each other, and a disposition space of the rotation detector 42 is less likely to be secured. In this regard, the rotation detector 42 of the present embodiment detects the extending portion 62 instead of the meshing portion 60 of the tooth portion 50. Therefore, the rotation detector 42 (sensor unit 64) is disposed in the vicinity of the extending portion 62 instead of in the vicinity of the meshing portion 60 of the tooth portion 50. Therefore, compared to when the meshing portion 60 of the tooth portion 50 is detected by the rotation detector 42, the meshing target member 54 and the rotation detector 42 are less likely to interfere with each other, and the disposition space of the rotation detector 42 is likely to be secured. (C) The tooth group 52 forms the first spline 56. Therefore, compared to when the

(B) The meshing target member 54 that meshes with the meshing portion 60 exists in the vicinity of the meshing portion 60 of the tooth portion 50. Therefore, when the meshing portion 60 of the tooth portion 50 is detected by the rotation detector 42, and when the rotation detector 42 (sensor unit 64) is disposed in the vicinity of the meshing portion 60, the rotation detector 42 and the meshing target member 54 are likely to interfere with each other, and a disposition space of the rotation detector 42 is less likely to be secured. In this regard, the rotation detector 42 of the present embodiment detects the extending portion 62 instead of the meshing portion 60 of the tooth portion 50. Therefore, the rotation detector 42 (sensor unit 64) is disposed in the vicinity of the extending portion 62 instead of in the vicinity of the meshing portion 60 of the tooth portion 50. Therefore, compared to when the meshing portion 60 of the tooth portion 50 is detected by the rotation detector 42, the meshing target member 54 and the rotation detector 42 are less likely to interfere with each other, and the disposition space of the rotation detector 42 is likely to be secured.

(C) The tooth group 52 forms the first spline 56. Therefore, compared to when thetooth group 52 forms gear teeth, the tooth group 52 is less likely to be worn by contact with the meshing target member 54, and the same shape can be stably maintained for a long period of time. As a result, when the rotation detector 42 detects the rotation of the rotator 40, stable detection performance can be achieved for a long period of time.

The sensor unit 64 of the rotation detector 42 is disposed to face the tooth group 52 in the radial direction. Therefore, compared to when the sensor unit 64 is disposed to face the tooth group 52 in the axial direction, when the rotator 40 and the rotation detector 42 are moved in the axial direction to be incorporated in other forming components of the rotating device 10, it is easy to avoid interference between the rotator 40 and the rotation detector 42.

### SECOND EMBODIMENT

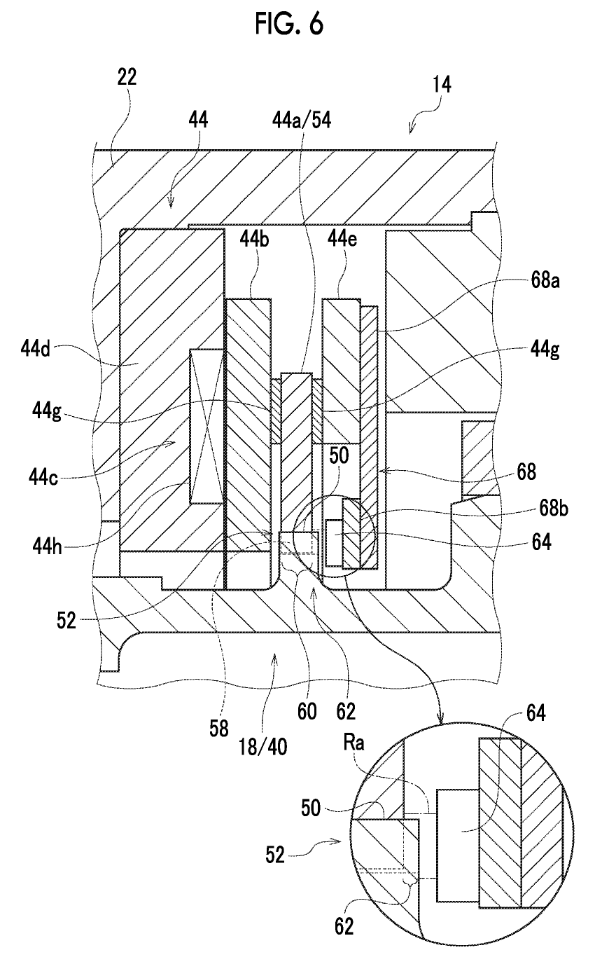

With reference to FIG. 6, a second embodiment will be described. In FIG. 6, a part of FIG. 6 is illustrated together with a partially enlarged view. The rotating device 10 of the present embodiment is different from that of the first embodiment in terms of a position of the sensor unit 64 of the rotation detector 42. The sensor unit 64 of the present embodiment is disposed to face the tooth group 52 in the axial direction. Specifically, the sensor unit 64 is disposed to face the extending portion 62 of each of the tooth portions 50 in the axial direction in the tooth group 52.

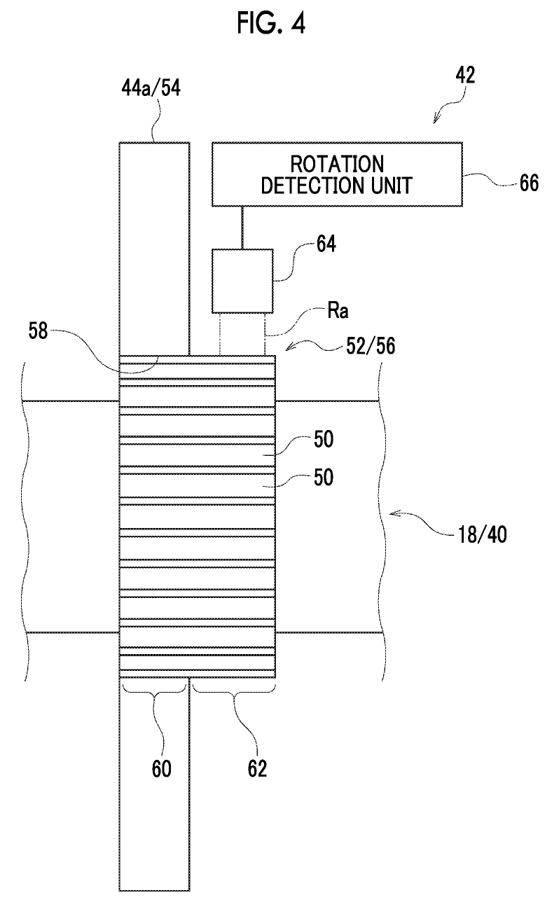

(D) When the sensor unit 64 of the rotation detector 42 is disposed to face the tooth group 52 in the radial direction, an axial dimension of the whole tooth group 52 needs to be made somewhat longer than that of the meshing portion 60 of the tooth portion 50 such that the tooth portion 50 exists within the detection range Ra (refer to FIG. 4) of the rotation detector 42. In this regard, the sensor unit 64 of the rotation detector 42 of the present embodiment is disposed to face the tooth group 52 in the axial direction. Therefore, each of the tooth portions 50 can exist within the detection range Ra of the sensor unit 64 even without making the axial dimension of the tooth group 52 longer than that of the meshing portion 60. Therefore, in detecting each of the tooth portions 50 of the tooth group 52, the extending portion 62 of the tooth portion 50 can be omitted, or the axial dimension of the extending portion 62 can be shortened. As a result, the tooth group 52 can be used as the detection target while the design change in the existing tooth group 52 is further suppressed.

The rotating device 10 of the present embodiment also includes the components described in (A1) to (A4), (B), and (C) described above, and can achieve the advantageous effects corresponding to the description of the components.

### THIRD EMBODIMENT

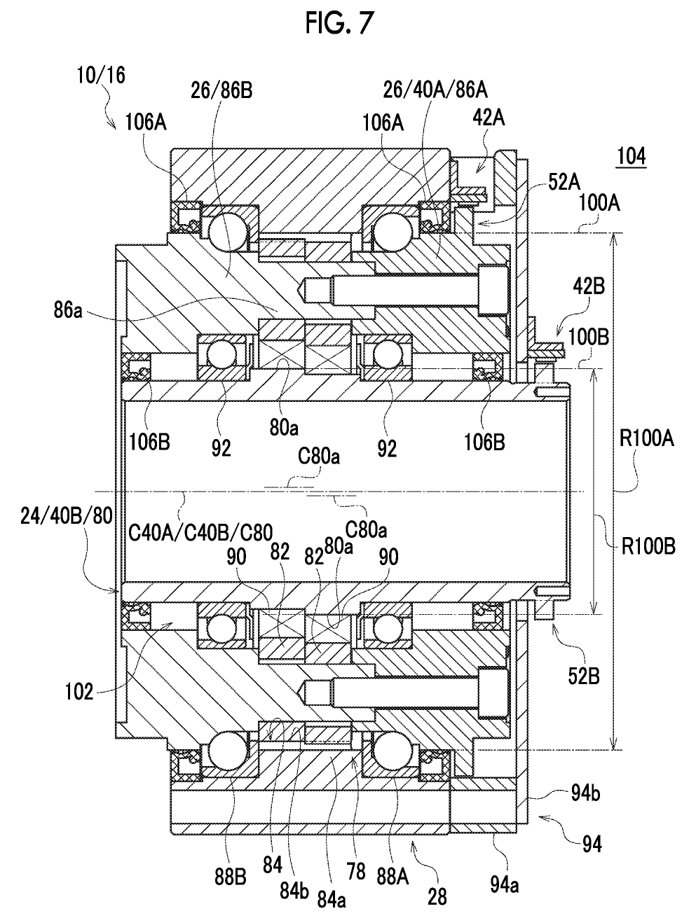

With reference to FIG. 7, a third embodiment will be described. The rotating device 10 of the present embodiment is a gear device 16. The gear device 16 is incorporated into a driven machine serving as a part of a driven machine. As in the first embodiment, the gear device 16 of the present embodiment also includes the input member 24 to which the input rotation is input from the drive device, a gear mechanism 78 that decelerates the input rotation of the input member 24, and the output member 26 that outputs the output rotation decelerated by the gear mechanism 78 to the driven member. The drive device may include various drive devices such as a gear motor and an engine in addition to the above-described motor device 14.

The gear device 16 of the present embodiment is an eccentric oscillation type gear device. The gear device 16 includes a crankshaft 80 having at least one eccentric portion 80a, an external gear 82 oscillated by the eccentric portion 80a, an internal gear 84 that meshes with the external gear 82, a gear device casing 28 integrated with the internal gear 84, carriers 86A and 86B disposed on a side in the axial direction with respect to the external gear 82, and main bearings 88A and 88B disposed between the carriers 86A and 86B and the gear device casing 28. In the present embodiment, the crankshaft 80 is the input member 24, the external gear 82 and the internal gear 84 are the gear mechanism 78, and the carriers 86A and 86B are the output member 26.

The crankshaft 80 of the present embodiment includes two eccentric portions 80a. The number of the eccentric portions 80a is not particularly limited, and may be one, three, or more. The eccentric portion 80a has a circular shape formed around an axial center C80a. The axial center C80a of the eccentric portion 80a is eccentric with respect to a rotation center C80 of the crankshaft 80.

The external gear 82 is individually provided corresponding to each of the plurality of eccentric portions 80a, and is supported to be relatively rotatable by the crankshaft 80 via an individual crank bearing 90. The internal gear 84 of the present embodiment includes an internal gear main body 84a integrated with the gear device casing 28, and an internal tooth portion 84b provided in an inner peripheral portion of the internal gear main body 84a. The internal tooth portion 84b of the present embodiment is integrated with the internal gear main body 84a. However, the internal tooth portion 84b may be configured to include an outer pin supported to be rotatable by the internal gear main body 84a. The carriers 86A and 86B of the present embodiment include a first carrier 86A disposed on one side (input side) in the axial direction with respect to the external gear 82, and a second carrier 86B disposed on the other side (counter-input side) in the axial direction with respect to the external gear 82. The carriers 86A and 86B support the crankshaft 80 to be rotatable via a bearing 92. The first carrier 86A and the second carrier 86B are integrated with each other by a pillar portion 86a protruding from one side.

The carriers 86A and 86B of the present embodiment include a first carrier 86A disposed on one side (input side) in the axial direction with respect to the external gear 82, and a second carrier 86B disposed on the other side (counter-input side) in the axial direction with respect to the external gear 82. The carriers 86A and 86B support the crankshaft 80 to be rotatable via a bearing 92. The first carrier 86A and the second carrier 86B are integrated with each other by a pillar portion 86a protruding from one side.

The main bearings 88A and 88B include a first main bearing 88A disposed between the first carrier 86A and the gear device casing 28, and a second main bearing 88B disposed between the second carrier 86B and the gear device casing 28. The main bearings 88A and 88B of the present embodiment are angular ball bearings. However, specific examples thereof are not particularly limited, and various types of bearings such as a tapered bearing, a cross roller bearing, and a ball bearing may be adopted.

An operation of the above-described gear device 16 will be described. When the input rotation is input to the input member 24 from the drive device, the gear mechanism 78 is operated. When the gear mechanism 78 is operated, the output rotation is transmitted from the gear mechanism 78 to the output member 26, and the output rotation is output to the driven member.

When the eccentric oscillation type gear device 16 is used as in the present embodiment, the crankshaft 80 is rotated by the input rotation input from the drive device. When the crankshaft 80 is rotated, the eccentric portion 80a causes the external gear 82 to oscillate such that the center of the external gear 82 rotates around the center of the internal gear 84. When the external gear 82 oscillates, a meshing position between the external gear 82 and the internal gear 84 is changed in the circumferential direction. Accordingly, each time the crankshaft 80 rotates once, one of the external gear 82 and the internal gear 84 (here, the external gear 82) rotates by a difference in the number of teeth between the external gear 82 and the internal gear 84, and an axial rotation component thereof is transmitted to the output member 26 (here, the carriers 86A and 86B) as the output rotation. A gear ratio (here, a reduction ratio) which is a ratio of the output rotation to the input rotation has a magnitude corresponding to the difference in the number of teeth between the external gear 82 and the internal gear 84.

In addition to the above-described gear mechanism 78, the rotating device 10 of the present embodiment includes a first rotator 40A and a second rotator 40B, a first rotation detector 42A that detects the rotation of the first rotator 40A, and a second rotation detector 42B that detects the rotation of the second rotator 40B. The first rotator 40A of the present embodiment is configured to include the carrier 86A, and the second rotator 40B is configured to include the crankshaft 80. The first rotator 40A and the second rotator 40B are rotated at different rotation speeds by the gear mechanism 78. In the present embodiment, when the rotating device 10 is operated, the first rotator 40A rotates at a relatively low rotation speed, and the second rotator 40B rotates at a relatively high rotation speed. The gear mechanism 78 of the present embodiment decelerates the rotation of the second rotator 40B, and transmits the rotation to the first rotator 40A.

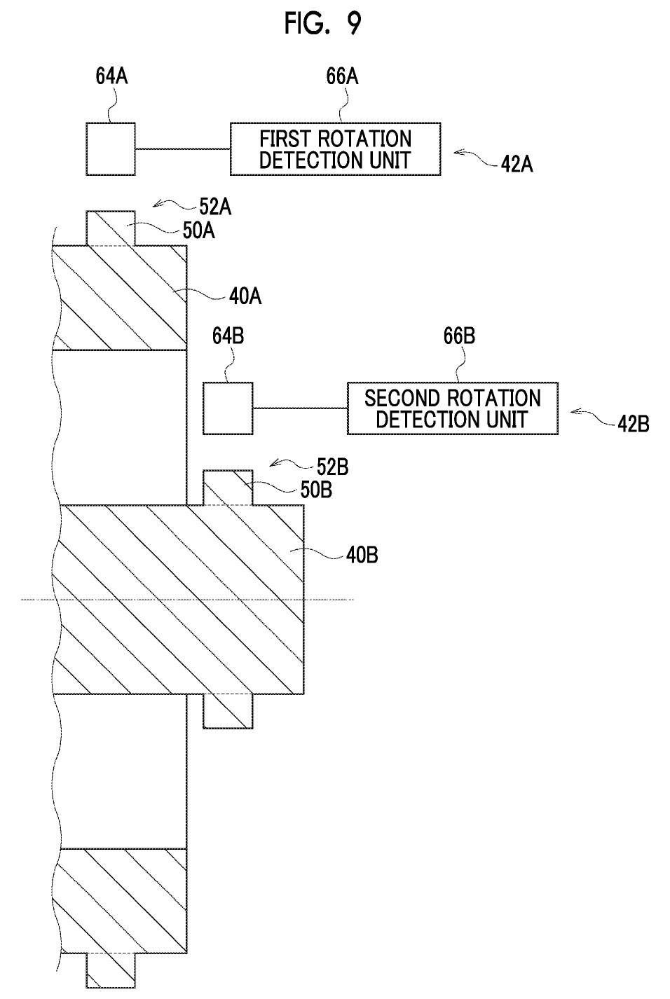

With reference to FIGS. 7, 8, and 9, the embodiment will be described. A first tooth group 52A including a plurality of first tooth portions 50A is formed in the first rotator 40A. A second tooth group 52B including a plurality of second tooth portions SOB is formed in the second rotator 40B. An example in which the plurality of tooth portions 50 of the first embodiment mesh with the meshing target member 54 has been described. In contrast, each of the tooth portions 50A and SOB does not mesh with other members. In addition, each of the tooth portions 50A and SOB does not include the extending portion 62 in addition to the meshing portion 60 as in the tooth portion 50 of the first embodiment. In addition, features of the first tooth portion 50A and the second tooth portion SOB are common to those of the tooth portion 50 described in the first embodiment unless otherwise specified. Therefore, description thereof will be omitted. The second tooth group 52B may function as an input gear that inputs the rotation to the crankshaft 80 by meshing with an input pinion to which the rotation of a drive source such as a motor is transmitted. In addition, the first tooth group 52A may be integrally formed with the carrier 86A, or may be a member separate from the carrier 86A, and may be connected to the carrier 86A to be integrally rotatable. The second tooth group 52B may be integrally formed with the crankshaft 80, or may be a member separate from the crankshaft 80, and may be connected to the crankshaft 80 to be integrally rotatable.

The first rotation detector 42A includes a first sensor unit 64A that detects the firsttooth portion 50A, a first rotation detection unit 66A that detects the rotation of the first rotator 40A, based on a detection signal detected by the first sensor unit 64A, and a first detector body portion 68A on which the first sensor unit 64A and the first rotation detection unit 66A are mounted. The second rotation detector 42B includes a second sensor unit 64B that detects the second tooth portion 50B, a second rotation detection unit 66B that detects the rotation of the second rotator 40B, based on a detection signal detected by the second sensor unit 64B, and a second detector body portion 68B on which the second sensor unit 64B and the second rotation detection unit 66B are mounted.

Features of each of the sensor units 64A and 64B are common to those of the sensor unit 64 of the first embodiment except that the detection targets are the first tooth portion 50A and the second tooth portion 50B. In addition, features of each of the rotation detection units 66A and 66B are common to those of the rotation detection unit 66 of the first embodiment except that the detection targets are the first rotator 40A and the second rotator 40B. Therefore, detailed description thereof will be omitted.

The rotating device 10 includes a cover 94 covering the first rotator 40A or the like in the axial direction and fixed to the gear device casing 28. The cover 94 includes a tubular member 94a fixed to the gear device casing 28, and an end plate member 94b fixed to the tubular member 94a and covering the first rotator 40A in the axial direction. A through-hole 94c through which the second rotator 40B (crankshaft 80) penetrates is formed in the end plate member 94b of the cover 94. A cutout portion 94d is formed in the tubular member 94a of the cover 94 at a position corresponding to the first rotation detector 42A, and the first rotation detector 42A is disposed inside the cutout portion 94d.

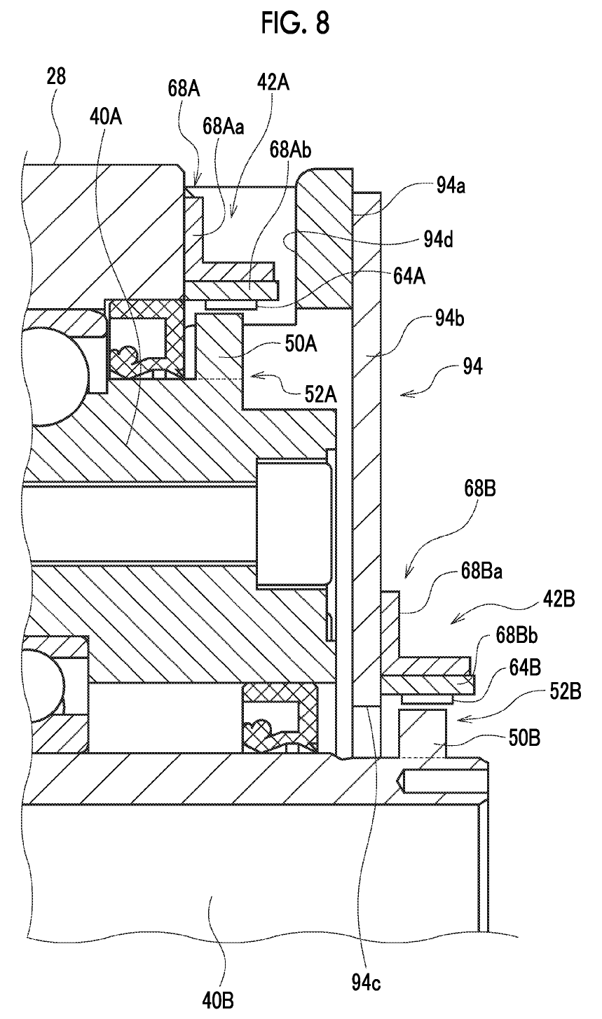

The first detector body portion 68A and the second detector body portion 68B are fixed to the gear device casing 28 serving as a forming member of the rotating device 10. The first detector body portion 68A includes a first fixing member 68Aa fixed to the geardevice casing 28, and a first circuit board 68Ab fixed to the first fixing member 68Aa. The first sensor unit 64A and the first rotation detection unit 66A (not illustrated in FIG. 8) are mounted on the first circuit board 68Ab.

The second detector body portion 68B is fixed to the gear device casing 28, and is fixed to the cover 94 serving as the forming member of the rotating device 10. Both the first detector body portion 68A and the second detector body portion 68B are directly or indirectly fixed to the forming member (here, the gear device casing 28) of the rotating device 10 rotated at the same rotation speed (including zero) when the first rotator 40A and the second rotator 40B are rotated. The second detector body portion 68B includes a second fixing member 68Ba fixed to the cover 94, and a second circuit board 68Bb fixed to the second fixing member 68Ba. The second sensor unit 64B and the second rotation detection unit 66B (not illustrated in FIG. 8) are mounted on the second circuit board 68Bb.

Advantageous effects of the rotating device 10 of the present embodiment will be described. In detecting the rotation of the first rotator 40A, the first rotation detector 42A detects the first tooth portion 50A by setting the first tooth group 52A formed in the first rotator 40A as the detection target. Therefore, even in the rotating device 10 of the present embodiment, it is not necessary to attach the target member to the first rotator 40A in detecting the rotation of the first rotator 40A. As a result, as in the above-described (A1), the target member is omitted, and the first tooth group 52A requiring low process costs is set as the detection target. In this manner, it is possible to achieve cost reduction of the rotating device 10. In addition, the advantageous effects corresponding to the description of (A2) and (A3) described above can be achieved by a relationship with the first rotator 40A.

When the second rotation detector 42B detects the rotation of the second rotator 40B, the second rotation detector 42B detects the second tooth portion 50B by setting the second tooth group 52B formed in the second rotator 40B as the detection target. Therefore,in detecting the rotation of the second rotator 40B, the target member does not need to be attached to the second rotator 40B. As a result, as in the above-described (A1), the target member is omitted, and the second tooth group 52B requiring low process costs is set as the detection target. In this manner, it is possible to achieve cost reduction of the rotating device 10. In addition, the advantageous effects corresponding to the description of (A2) to (A3) described above can be achieved by a relationship with the second rotator 40B.

Next, other features of the rotating device 10 of the present embodiment will be described. With reference to FIG. 7, description will be continued. The first tooth group 52A is formed in an outer peripheral portion of the first rotator 40A. A diameter R100A of a tooth bottom circle 100A of the first tooth group 52A is larger than a diameter R100B of a circumscribed circle 100B having a maximum diameter which circumscribes the second rotator 40B. In FIG. 7, reference numerals are assigned to locations where the tooth bottom circle 100A and the circumscribed circle 100B are extended in the axial direction. The tooth bottom circle 100A is a virtual circle concentric with a rotation center C40A of the first rotator 40A, and inscribes a tooth bottom of each of the first tooth portions 50A of the first tooth group 52A. The circumscribed circle 100B is a virtual circle concentric with a rotation center C40B of the second rotator 40B, and circumscribes the second rotator 40B at a location other than the second tooth group 52B. The circumscribed circle 100B of the present embodiment circumscribes each eccentric portion 80a of the second rotator 40B.

When the first tooth group 52A is formed in an outer peripheral portion of the second rotator 40B, the diameter R100A of the tooth bottom circle of the first tooth group 52A is equal to or smaller than the diameter R100B of the circumscribed circle 100B that circumscribes the second rotator 40B. In contrast, as described above, the diameter R100A of the tooth bottom circle of the first tooth group 52A is set to be larger than the diameter R100B of the circumscribed circle 100B. In this manner, compared to when the first toothgroup 52A is formed in the second rotator 40B (case of R100A < R100B), the pitch circle of the first tooth group 52A can be increased, and accordingly, the number of teeth of the first tooth group 52A can be easily increased. As the number of teeth of the first tooth group 52A increases, the number of cycles per one rotation of the first rotator 40A in the detection signal detected by the first sensor unit 64A of the first rotation detector 42A can be increased. As a result, a resolution of the first rotation detector 42A can be improved in detecting the rotation of the first rotator 40A.

The rotating device 10 includes seal members 106A and 106B that isolate an internal space 102 and an external space 104 of the rotating device 10 from each other. The internal space 102 is sealed with a lubricant such as a lubricating oil and grease. The lubricant is used to lubricate a lubrication target member accommodated in the internal space 102. The lubrication target member refers to a member which comes into rolling contact or sliding contact with another member since the member itself or another member moves during an operation of the rotating device 10 (member to be worn). A contact target member of the present embodiment refers to the internal gear 84, the external gear 82, each of the bearings 88A, 88B, 90, and 92, and the like. The seal members 106A and 106B are contact type seals such as an oil seal, an O-ring, and a seal cap. The seal members 106A and 106B prevent the lubricant sealing the internal space 102 from leaking to the external space 104. The seal members 106A and 106B of the present embodiment include a first seal member 106A disposed between the gear device casing 28 and the carriers 86A and 86B, and a second seal member 106B disposed between the carriers 86A and 86B and the crankshaft 80. Each of the first tooth group 52A and the second tooth group 52B is disposed in the external space 104 of the rotating device 10. Each of the first rotation detector 42A and the second rotation detector 42B is also disposed in the external space 104 of the rotating device 10. The tooth groups 52A and 52B and the rotation detectors 42A and 42B are all disposed outside the first main bearing 88A in the axial direction. Since the tooth groups 52A and 52B and the rotation detectors 42A and 42B are disposed in the external space 104 in this way, the lubricant sealing the internal space 102 of the rotating device 10 does not need to come into contact with the tooth groups 52A and 52B and the rotation detectors 42A and 42B. As a result, the lubricant adhering to the tooth groups 52A and 52B or the like during maintenance of the tooth groups 52A and 52B and the rotation detectors 42A and 42B does not need to be removed, and workability during the maintenance is satisfactory. In achieving the same advantageous effects, even when the tooth group 52 that meshes with the meshing target member 54 described in the first embodiment or the like is formed in the rotator 40, the tooth group 52 and the rotation detector 42 may be disposed in the external space 104 of the rotating device 10.

### FOURTH EMBODIMENT

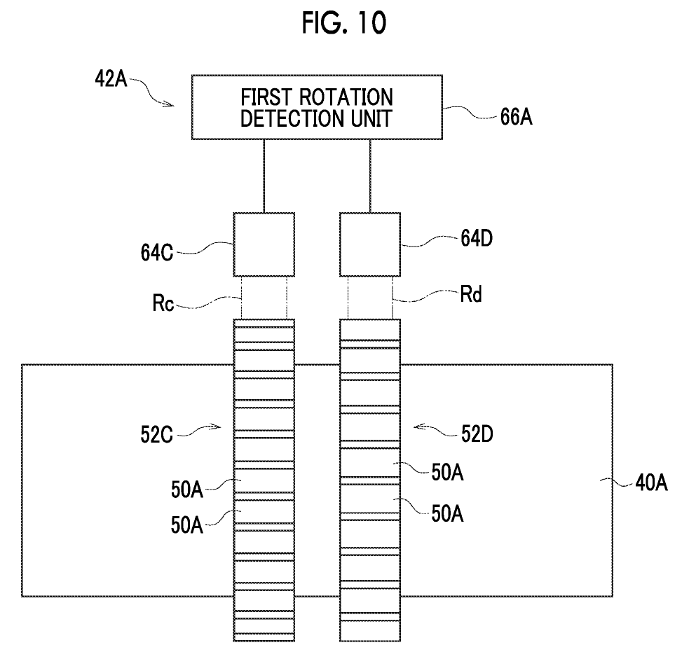

With reference to FIG. 10, a fourth embodiment will be described. In the rotating device 10 of the present embodiment, the configurations relating to first tooth groups 52C and 52D formed in the first rotator 40A and first sensor units 64C and 64D of the first rotation detector 42A are different from those of the third embodiment. In the third embodiment, "52A" is used for the reference numeral of the first tooth group, but "52C" and "52D" are used herein for convenience of description. In addition, in the third embodiment, "62A" is used for the reference numeral of the first sensor unit, but "62C" and "62D" are used herein for convenience of description. In FIG. 10, only the first rotator 40A and the first rotation detector 42A (first detector body portion 68A is omitted) of the third embodiment are schematically illustrated.

The first tooth groups 52C and 52D include a tooth group having a large number of teeth 52C and a tooth group having a small number of teeth 52D, which are formed in the common first rotator 40A and have different numbers of teeth from each other. The number of teeth N1 of the tooth group having the large number of teeth 52C is larger than the number of teeth N2 of the tooth group having the small number of teeth 52D. For example, the number of teeth N1 is 100, the number of teeth N2 is 99, and a difference in the number of teeth between both of these is 1.

The first sensor units 64C and 64D of the first rotation detector 42A include the sensor unit for a large number of teeth 64C which detects each of the first tooth portions 50A of the tooth group having the large number of teeth 52C, and the sensor unit for a small number of teeth 64D which detects each of the first tooth portions 50A of the tooth group having the small number of teeth 52D. The sensor unit for the large number of teeth 64C detects a change in the physical quantity when each of the first tooth portions 50A of the tooth group having the large number of teeth 52C passes through a detection range Rc of the sensor unit for the large number of teeth 64C, thereby detecting each of the first tooth portions 50A. In this case, the sensor unit for the large number of teeth 64C detects a detection signal for a large number of teeth which indicates each of the first tooth portions 50A of the tooth group having the large number of teeth 52C. The sensor unit for the small number of teeth 64D detects a change in the physical quantity when each of the first tooth portions 50A of the tooth group having the small number of teeth 52D passes through a detection range Rd of the sensor unit for the small number of teeth 64D, thereby detecting each of the second tooth portions 50B. In this case, the sensor unit for the small number of teeth 64D detects a detection signal for a small number of teeth which indicates each of the first tooth portions 50A of the tooth group having the small number of teeth 52D.

The detection signal for the large number of teeth which is detected by the sensor unit for the large number of teeth 64C has a periodic waveform in which the number of cycles per one rotation of the first rotator 40A is the same as the number of teeth N1 of the tooth group having the large number of teeth 52C. The detection signal for the small number of teeth detected by the sensor unit for the small number of teeth 64D has a periodic waveform in which the number of cycles per one rotation of the first rotator 40A is the same as the number of teeth N2 of the tooth group having the small number of teeth 52D. A difference between the number of cycles per one rotation of the detection signal for the large number of teeth and the number of cycles per one rotation of the detection signal for the small number of teeth is 1, as in the difference in the number of teeth between the tooth group having the large number of teeth 52C and the tooth group having the small number of teeth 52D. In this way, when two detection signals having different numbers of cycles per one rotation (in particular, two detection signals in which the numbers of cycles are different by only one) are detected, it is known that an absolute position of the first rotator 40A can be detected from a phase difference Ap between the two detection signals. The phase difference Ap is a signal that is periodically changed while one rotation of the first rotator 40A is set as one cycle, and has a magnitude uniquely determined with respect to a mechanical angle of the first rotator 40A. A difference in the numbers of teeth (= N1 - N2) between the tooth group having the large number of teeth 52C and the tooth group having the small number of teeth 52D is set such that the phase difference Ap between the detection signal for the large number of teeth and the detection signal for the small number of teeth is uniquely determined with respect to the mechanical angle of the first rotator 40A. The difference in the numbers of teeth for realizing this configuration is typically 1.

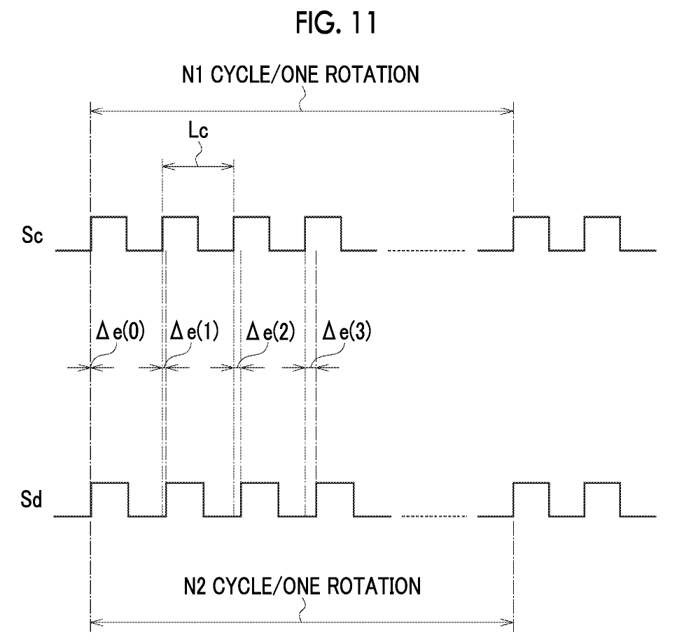

A method for detecting the absolute position of the rotator by using the phase difference between the detection signal for the large number of teeth and the detection signal for the small number of teeth is not particularly limited, and various methods including a known method may be used. This example will be described. With reference to FIG. 11, description will be continued. The first rotation detection unit 66A of the first rotation detector 42A generates an incremental signal for a large number of teeth Sc, which includes apulse waveform corresponding to the detection signal for the large number of teeth, by performing waveform shaping on the detection signal for the large number of teeth. Similarly, the first rotation detection unit 66A generates an incremental signal for a small number of teeth Sd, which includes a pulse waveform corresponding to the detection signal for the small number of teeth, by performing waveform shaping on the detection signal for the small number of teeth. The incremental signal for the large number of teeth Sc has a periodic waveform in which the number of cycles per one rotation of the first rotator 40A is the same as the number of teeth N1 of the tooth group having the large number of teeth 52C. The incremental signal for the small number of teeth Sd has a periodic waveform in which the number of cycles per one rotation of the first rotator 40A is the same as the number of teeth N2 of the tooth group having the small number of teeth 52D.

A time interval between reference edges closest to the respective incremental signals Sc and Sd in time will be referred to as an edge time interval Ae(n). n is a natural number of 0 or more. The reference edge here refers to a rising edge or a falling edge of the pulse waveform, and an example of the rising edge will be described here. In this case, for example, the above-described phase difference Ap is specified as a value obtained by dividing the edge time interval Ae(n) of the incremental signals Sc and Sd by a cycle length Lc of the incremental signal for the large number of teeth Sc. The cycle length Lc refers to a time interval from the reference edge of the incremental signal for the large number of teeth Sc which is used for specifying the edge time interval Ae(n) to the reference edge of a subsequent cycle. The first rotation detection unit 66A detects the edge time interval Ae(n) and the cycle length Lc of the respective incremental signals Sc and Sd, and calculates the phase difference Ap (= edge time interval Ae(n) / cycle length Lc) specified in this way, based on a detection result. The first rotation detection unit 66A stores relationship information (look-up table or the like) indicating a relationship between the calculated phase difference Ap and the absolute position of the first rotator 40A in advance, and detects the absolute position of the first rotator 40A, based on the phase difference Ap calculated with reference to the relationship information.

In addition, the phase difference Ap between the detection signal for the large number of teeth and the detection signal for the small number of teeth may be specified as an angle difference between an electrical angle of the detection signal for the large number of teeth and an electrical angle of the detection signal for the small number of teeth. For example, a mechanical angle when the first rotator 40A is rotated once is 360° , an electrical angle 6el of the detection signal for the large number of teeth at that time is 360° x N1, and an electrical angle 6e2 of the detection signal for the small number of teeth at that time is 360° x N2. The electrical angle 6el of the detection signal for the large number of teeth within one cycle can be calculated by using the detection signal for the large number of teeth (sin signal, cos signal) in the A phase and the B phase which have phases different from each other, and through conversion using an inverse tangent function (Oe = arctan(sin/cos)). The electrical angle 6e2 within one cycle of the detection signal for the small number of teeth is also the same. Based on the electrical angles 6el and 6e2 of the respective detection signals within one cycle which are calculated in this way, the electrical angles 6el and 6e2 of each detection signal within one rotation of the first rotator 40A can be calculated. Since the angle difference between the electrical angles 6el and 6e2 of the respective detection signals calculated in this way within one rotation (= 6e2 - 6el) is calculated as a phase difference Ap, the calculation value may be detected as the absolute position of the rotator 40.

As described above, the first rotation detector 42A detects the absolute position of the first rotator 40A by individually detecting the first tooth portion 50A of each of the tooth group having the large number of teeth 52C and the tooth group having the small number of teeth 52D. Therefore, in detecting the absolute position of the first rotator 40A, it is not necessary to attach the target member for an absolute encoder to the rotator 40. In addition, in order to realize this configuration, only the tooth group having the large number of teeth 52C and the tooth group having the small number of teeth 52D may be formed by performing the gear cutting process on the common rotator material. Therefore, in detecting the absolute position of the rotator 40, cost reduction of the rotating device 10 can be achieved, compared to when the target member for the absolute encoder is used. In addition, in the present embodiment, the same advantageous effects as those of the third embodiment can be achieved.

In detecting the absolute position of the rotator 40 by the rotation detector 42 as described above, the tooth group having the large number of teeth 52C and the tooth group having the small number of teeth 52D may mesh with the meshing target member 54 as described in the first embodiment. In this case, the tooth group having the small number of teeth 52D and the tooth group having the large number of teeth 52C which are formed in the common rotator 40 may mesh with the individual meshing target member 54. In addition, in this case, as in the first embodiment, the first tooth portion 50A of the tooth group having the large number of teeth 52C and the tooth group having the small number of teeth 52D may include the meshing portion 60 and the extending portion 62.

### FIFTH EMBODIMENT

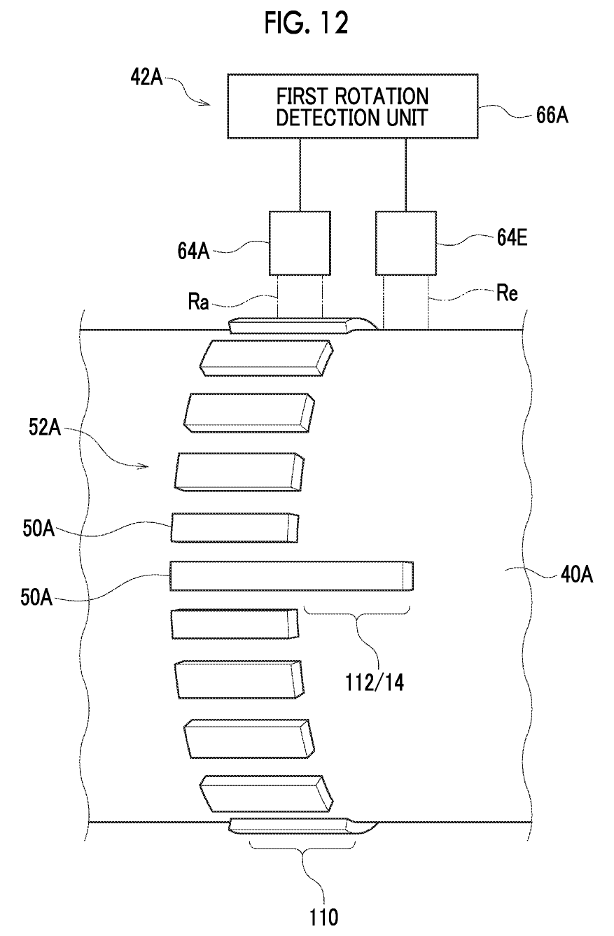

With reference to FIG. 12, a fifth embodiment will be described. In the rotating device 10 of the present embodiment, the configuration of the first tooth group 52A formed in the first rotator 40A and the first rotation detector 42A is different from that in the third embodiment. In FIG. 12, only the first rotator 40A and the first rotation detector 42A (first detector body portion 68A is omitted) of the third embodiment are schematically illustrated.

The first tooth group 52A includes a tooth group body portion 110 for generating the incremental signal and an origin signal generation portion 112 for generating an origin signal. The tooth group body portion 110 is a portion that includes the first tooth portions 50A corresponding to the number of teeth of the first tooth group 52A. In the tooth group body portion 110, the first tooth portions 50A corresponding to the number of teeth of the first tooth group 52A is provided at an equal pitch in the circumferential direction.

The origin signal generation portion 112 of the present embodiment is configured to include an extension tooth portion 114 in which the first tooth portion 50A (here, one tooth portion), which is a portion of the tooth group body portion 110, extends in the axial direction with respect to the tooth group body portion 110. The origin signal generation portion 112 configured to include the extension tooth portion 114 is provided as a protrusion portion on a peripheral surface portion of the first rotator 40A. The tooth group body portion 110 is formed by performing the gear cutting process on the rotator material. When the extension tooth portion 114 is formed, for example, first, a plurality of the first tooth portions 50A are formed in the rotator material at an equal pitch in a certain range of the tooth group body portion 110 and the extension tooth portion 114 in the axial direction by performing the gear cutting process. Thereafter, in the certain range of the extension tooth portion 114 in the axial direction, the plurality of first tooth portions 50A are formed by cutting a portion of the first tooth portion 50A which is not the extension tooth portion 114.

In addition to the first sensor unit 64A that detects the tooth portion 50 of the tooth group body portion 110, the first rotation detector 42A includes a sensor unit for an origin signal 64E which detects the origin signal generation portion 112. The first sensor unit 64A detects the tooth portion 50 by detecting a change in the physical quantity when the tooth portion 50 of the tooth group body portion 110 passes through the detection range Ra of the first sensor unit 64A. The sensor unit for the origin signal 64E detects the origin signal generation portion 112 by detecting a change in the physical quantity when the origin signal generation portion 112 passes through a detection range Re of the origin signal sensor unit 64E.

The first rotation detection unit 66A generates the incremental signals Sb 1 and Sb2 as described in the first embodiment, based on a detection signal detected by the first sensor unit 64A. In addition, the first rotation detection unit 66A generates the origin signal (Z- phase signal), based on the detection signal detected by the sensor unit for the origin signal 64E. The origin signal includes a pulse signal having one pulse per one rotation of the rotator 40, and is a signal for specifying an origin position of the rotator 40. A method for generating the origin signal based on the detection signal of the sensor unit for the origin signal 64E is not particularly limited, and various methods including a known method may be adopted. For example, the rotation detection unit 66 may generate the origin signal by outputting one pulse signal when a waveform indicating the origin signal generation portion 112 is detected in the detection signal of the sensor unit for the origin signal 64E. The rotation detection unit 66 detects the absolute position based on the origin position specified by the origin signal, based on the incremental signals Sb 1 and Sb2 and the origin signal. In this case, for example, the rotation detection unit 66 may reset a count value of the incremental signals Sb1 and Sb2 each time the origin signal is generated, and detect the count value as the absolute position of the rotator 40. The rotation detection unit 66 detects the count value of the incremental signal counted until one rotation after the origin signal is generated, as the absolute position of the first rotator 40A.

(El) As described above, the first tooth group 52A includes the origin signal generation portion 112 in addition to the tooth group body portion 110. Therefore, the absolute position of the first rotator 40A can be detected by using the tooth group body portion 110 and the origin signal generation portion 112 of the first tooth group 52A formed in the first rotator 40A.

(E2) The origin signal generation portion 112 is configured to include the extension tooth portion 114 extending from the tooth portion 50. Therefore, even when the origin signal generation portion 112 is provided in the first tooth group 52A in addition to the tooth group body portion 110, only a simple cutting process may be performed in addition to the gear cutting process. Therefore, the manufacturing costs are hardly increased. As a result, even in this case, it is possible to achieve an advantageous effect of achieving cost reduction of the rotating device 10 described in (A1). In addition, in the present embodiment, the same advantageous effects as those of the third embodiment can be achieved.

### SIXTH EMBODIMENT

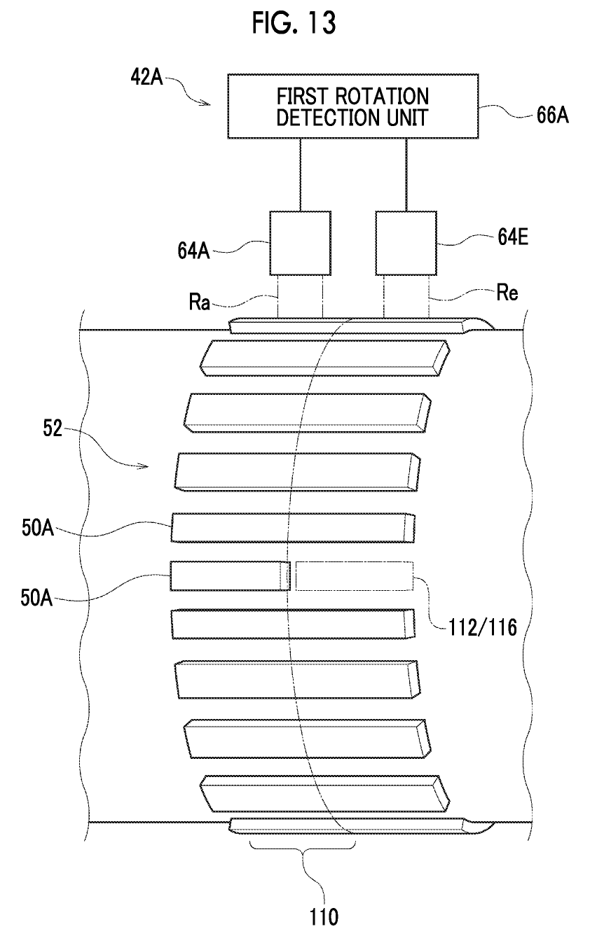

With reference to FIG. 13, a sixth embodiment will be described. In the rotating device 10 of the present embodiment, the configuration of the first tooth group 52A formed in the first rotator 40A is different from that in the fifth embodiment. In FIG. 13, as in FIG. 12, only the first rotator 40A and the first rotation detector 42A (first detector body portion 68A is omitted) of the third embodiment are schematically illustrated.

The origin signal generation portion 112 of the first tooth group 52A is configured to include a cutout portion 116 in which a partial range in the axial direction in the first tooth portion 50A (here, one tooth portion) of a portion of the first tooth group 52A is cut out. The first tooth portions 50A other than the first tooth portion 50A in which the cutout portion 116 is formed extends in the axial direction with respect to the tooth group body portion 110 of the first tooth group 52A. In a certain range in the axial direction (range in the axial direction in which the cutout portion 116 is formed) of the origin signal generation portion 112, the apparent number of teeth is smaller than the number of teeth of the tooth group body portion 110. For example, in forming the respective tooth portions 50 of the tooth group 52 by performing the gear cutting process, the cutout portion 116 is formed by cutting out the tooth portion 50 of the tooth group 52. In this manner, the same advantageous effects as those of the above-described (El) and (E2) can be achieved. In addition, in the present embodiment, the same advantageous effects as those in the third embodiment can also be achieved.

Even in the tooth group 52 that meshes with the meshing target member 54 as described in the first embodiment, the tooth group 52 may include the origin signal generation portion 112 in addition to the tooth group body portion 110.

Next, modification forms of the respective components described so far will be described.

The rotating device 10 may include the rotator 40 and the rotation detector 42 that detects the rotation of the rotator 40. In realizing this configuration, the rotating device 10 has been described by using an example of the actuator 12 and the gear device 16. However, specific examples thereof are not particularly limited, and the motor device 14, a traction drive, or the like may be adopted. The specific example of the gear device 16 is not particularly limited, and the gear device 16 may be configured to include various gear devices such as an eccentric oscillation type gear device (including a center crank type and a distribution type), a bending meshing type gear device (including a tubular type, a cup type, and a silk hat type), a planetary gear device, a perpendicular shaft gear device, and a parallel shaft gear device.

A specific example of the rotator 40 that is the rotation detection target of the rotation detector 42 is not particularly limited. The rotator 40 may be a rotary shaft (input shaft, output shaft, or the like), a gear, a casing, a bearing (outer ring, inner ring, or the like), a brake rotor, or the like.

When the tooth group 52 forms the first spline 56, specific examples of the meshing target member 54 spline-connected to the rotator 40 are not particularly limited. For example, the meshing target member 54 may be a gear or a rotary shaft in addition to the brake rotor. When the meshing target member 54 is the gear (here, referred to as a first gear), the rotator 40 is another gear (here, referred to as a second gear). In this case, the tooth group 52 formed in the second gear serving as the rotator 40 forms gear teeth of the second gear itself which mesh with gear teeth of the first gear. The tooth group 52 forming the gear teeth meshes with the gear teeth of the first gear serving as the meshing target member 54. In this manner, power can be transmitted between the first gear and the tooth group 52.

The tooth group 52 may include only the meshing portion 60, and does not need to include the extending portion 62. In this case, the rotation detector 42 may detect the rotation of the rotator 40 by detecting the meshing portion 60 of the tooth portion 50. In this case, the sensor unit 64 of the rotation detector 42 may be disposed at a position facing any one of the axial direction and the radial direction of the meshing portion 60.

An example has been described in which the gear mechanism 78 changes the speed of the rotation of the second rotator 40B (crankshaft 80) and transmits the changed speed of the rotation to the first rotator 40A (carrier 86A). That is, in the third embodiment, it is assumed that the second rotator 40B is the input member 24, the first rotator 40A is the output member 26, and the rotation of the input member 24 is decelerated by the gear mechanism 78. Alternatively, the gear mechanism 78 may change the speed of the rotation of the first rotator 40A, and may transmit the changed speed of the rotation to the second rotator 40B. That is, in the third embodiment, it is assumed that the first rotator 40A is the input member 24, the second rotator 40B is the output member 26, and the rotation of the input member is accelerated by the gear mechanism 78. In this way, the gear mechanism 78 may change the speed of the rotation of one of the first rotator 40A and the second rotator 40B, and thereafter, may transmit the changed speed of the rotation to the other. In addition, specific examples of the first rotator 40A and the second rotator 40B are not particularly limited. For example, in various gear devices, one of the first rotator 40A and the second rotator 40B may be the input member 24, and the other may be the output member 26. In addition, in the gear device 16 of the third embodiment, the first rotator 40A may be the crankshaft 80, and the second rotator 40B may be the carriers 86A and 86B. In addition, the second rotation detector 42B may be omitted by applying the contents of the present disclosure to the rotating device 10 including the first rotator 40A and the second rotator 40B

The shape of the plurality of tooth portions 50 is not particularly limited. For example, a shape that satisfies dimensions defined in a JIS standard specification (for example, DIN5480, JIS B 1603, or the like) that defines a tooth profile shape such as a spline shape may be adopted. In this manner, the shape of the tooth group 52 can be easily realized without a need for a dedicated design.

The rotating device 10 may include a plurality of the rotation detectors 42 that detect the rotation of the common rotator 40, in which the tooth group 52 is formed, by detecting the common tooth portion 50 of the common tooth group 52. In this manner, even when one of the rotation detectors 42 fails, the rotation of the rotator 40 can be detected by using the remaining rotation detector 42, and thus redundancy can be improved.

In some cases of measuring a backlash of gears that mesh with each other, the rotation of each gear may be detected by a separate rotation detector corresponding to each of the gears, and a detection result may be used. As the rotation detector used for this case, the rotation detector 42 that detects the tooth portion 50 of the present disclosure may be used.

The positions of the rotation detector 42 and the position of the tooth group 52 are not particularly limited. For example, the rotation detector 42 may be disposed between any one of the main bearings 88A and 88B and the internal gear 84. In this case, the tooth group 52 may be formed in the rotator such as a carrier at a position facing the rotation detector 42 in the radial direction.

In the fourth embodiment, the configurations (tooth group having the large number of teeth 52C, tooth group having the small number of teeth 52D, sensor unit for the large number of teeth 64C, and sensor unit for the small number of teeth 64D) applied to the first rotator 40A and the first rotation detector 42A for detecting the absolute position of the first rotator 40A have been described. These configurations may be applied to the second rotator 40B and the second rotation detector 42B to detect the absolute position of the second rotator 40B. Specifically, the tooth group having the large number of teeth 52C and the tooth group having the small number of teeth 52D which are used for the first rotator 40A may be applied to the second rotator 40B. In addition, the second rotation detector 42B may include the sensor unit for the large number of teeth 64C which detects the tooth group having the large number of teeth 52C of the second rotator 40B and the sensor unit for the small number of teeth 64D which detects the tooth group having the small number of teeth 52D.

In the fifth and sixth embodiments, the configurations (tooth group body portion 110, origin signal generation portion 112, and sensor unit for the origin signal 64E) applied to the first rotator 40A and the first rotation detector 42A for detecting the absolute position of the first rotator 40A have been described. These configurations may be applied to the second rotator 40B and the second rotation detector 42B to detect the absolute position of the second rotator 40B. Specifically, the tooth group body portion 110 and the origin signal generation portion 112 which are used for the first tooth group 52A of the first rotator 40A may be applied to the second tooth group 52B of the second rotator 40B. In addition, the second rotation detector 42B may include the sensor unit for the origin signal 64E which detects the origin signal generation portion 112 of the second rotator 40B in addition to the second sensor unit 64B that detects the tooth group body portion 110 of the second rotator 40B.

In disposing the tooth groups 52A and 52B of the rotators 40A and 40B in the external space 104, the tooth groups 52A and 52B may mesh with the meshing target member 54 as in the first embodiment, or do not need to mesh with the meshing target member 54 as in the third embodiment.

The above-described embodiments and modification forms are examples. Technical ideas achieved by abstracting the embodiments and the modification forms should not be construed as limited to the contents of the embodiments and the modification forms. Many design changes such as modifications, additions, and deletions of the components can be made in the contents of the embodiments and the modification forms. In the above-described embodiments, the contents enabling the design changes are emphasized by assigning the notation of the "embodiments". However, the design changes are allowed even when there is no notation in the contents. A hatched cross section in the drawings does not limit a material of a hatched object. The components including a single member in the embodiments may include a plurality of members. Similarly, the components including a plurality of members in the embodiments may include a single member.

Any combination between the above-described components is also valid. For example, any described items in one embodiment may be combined with those of another embodiment, or any described items in one embodiment and other modification forms may be combined with another modification form.

The present disclosure relates to a rotating device. It should be understood that the invention is not limited to the above-described embodiment, but may be modified into various forms on the basis of the spirit of the invention. Additionally, the modifications are included in the scope of the invention.

What is claimed is:

1. A rotating device comprising:
a rotator; and
a rotation detector that detects rotation of the rotator,
wherein a tooth group including a plurality of tooth portions meshing with a meshing target member is formed in the rotator, and
the rotation detector detects the tooth portion to detect the rotation of the rotator.

2. The rotating device according to claim 1,
wherein the tooth portion includes a meshing portion meshing with the meshing target member, and an extending portion extending from the meshing portion in an axial direction, and
the rotation detector detects the extending portion to detect the rotation of the rotator.

3. The rotating device according to claim 2,
wherein the extending portion does not mesh with the meshing target member.

4. The rotating device according to claim 1,
wherein the tooth group forms a spline that spline-connects a brake rotor and the rotator.

5. The rotating device according to claim 4,
wherein the tooth group forms a first spline, a second spline that meshes with the first spline is formed in the meshing target member, and one of the first spline and the second spline is a male spline and the other is a female spline.

6. The rotating device according to claim 1,
wherein the rotation detector includes a sensor unit that detects the tooth portion, and the sensor unit is disposed to face the tooth group in a radial direction.

7. The rotating device according to claim 1,
wherein the rotation detector includes a sensor unit that detects the tooth portion, and the sensor unit is disposed to face the tooth group in an axial direction.

8. A rotating device comprising:
a first rotator and a second rotator;
a gear mechanism that changes a speed of rotation of one of the first rotator and the second rotator and that transmits the rotation to the other; and
a first rotation detector that detects rotation of the first rotator,
wherein a tooth group including a plurality of tooth portions is formed in the first rotator, and
the first rotation detector detects the tooth portion in the first rotator to detect the rotation of the first rotator.

9. The rotating device according to claim 8, further comprising:
a second rotation detector that detects rotation of the second rotator,
wherein a tooth group including a plurality of tooth portions is formed in the second rotator, and
the second rotation detector detects the tooth portion in the second rotator to detect the rotation of the second rotator.

10. The rotating device according to claim 8,
wherein a diameter of a tooth bottom circle of the tooth group in the first rotator is larger than a diameter of a circumscribed circle having a maximum diameter, which circumscribes the second rotator.

11. The rotating device according to claim 1,
wherein the tooth group includes a tooth group having a large number of teeth and a tooth group having a small number of teeth, which are formed in a common rotator and have different numbers of teeth from each other, and
the rotation detector detects an absolute position of the rotator by individually detecting the tooth portion of each of the tooth group having the large number of teeth and the tooth group having the small number of teeth.

12. The rotating device according to claim 1,
wherein the tooth group includes a tooth group body portion for generating an incremental signal, and an origin signal generation portion for generating an origin signal.

13. The rotating device according to claim 12,
wherein the origin signal generation portion includes an extension tooth portion in which a first tooth portion, which is a portion of the tooth group body portion, extends in an axial direction with respect to the tooth group body portion, and is provided as a protrusion portion on a peripheral surface portion of the rotator.

14. The rotating device according to claim 13,
wherein the tooth group and one or more tooth groups are formed at an equal pitch in a circumferential direction on the peripheral surface portion of the rotator.

15. The rotating device according to claim 14,
wherein the extension tooth portion is formed by forming the first tooth portion and one or more additional first tooth portions in a rotator material at an equal pitch in a certain range of the extension tooth portion in the axial direction by performing a gear cutting process, and by cutting a portion of the first tooth portion which is not the extension tooth portion in the certain range of the extension tooth portion in the axial direction.

16. The rotating device according to claim 1, further comprising:
a seal member that isolates an internal space and an external space of the rotating device from each other,
wherein the internal space is sealed with a lubricant, and
the tooth group is disposed in the external space.
